(19) United States
(12) Patent Application Publication
(10) Pub. No.: US 2012/0064484 A1
(43) Pub. Date: Mar. 15, 2012

(54) INFERIOR ALVEOLAR NERVE (IAN) PROTECTOR INSTRUMENT

(76) Inventors: ALI HASSANI, Tehran (IR); Seyed Aliakbar Vahdati, Los Angeles, CA (US)

(21) Appl. No.: 12/881,237

(22) Filed: Sep. 14, 2010

(51) Int. Cl. A61C 3/00

(52) U.S. Cl. 433/144

(57) ABSTRACT

The various embodiments of the present invention provide an inferior alveolar nerve (IAN) protector instrument for proper protection of neurovascular bundle and to prevent the traumatic injuries during oral and maxillofacial surgeries. The IAN protector instrument made of stainless steel has a shank, a blade and a handle. The shank is formed to serve as a soft tissue flap retractor while supporting the blade. The handle is designed with a finger rest for more control and in the pear shape for palm grasp. The shank is bent twice at 120 degrees. The blade is curved with a radius of curvature equal to ⅙-⅛ of a complete circle. The dissecting edge and both lateral line angles are rounded to avoid untoward cutting. The instrument is designed separately for right and left sides of the mouth.

### SPONSORSHIP STATEMENT

Iranian National Science Foundation sponsors the present invention for international filing.

### BACKGROUND

1. Technical Field

The embodiments herein generally relate to an oral and maxillofacial surgery. The embodiments herein particularly relate to a nerve bundle preservation during oral and maxillofacial surgeries. The embodiments herein more particularly relate to an inferior alveolar nerve (IAN) protector instrument.

2. Description of the Related Art

The inferior alveolar nerve also known as the inferior dental nerve is a branch of the mandibular nerve, which is itself the third branch of the trigeminal nerve or cranial nerve. In sever atrophied mandibles, the inferior alveolar nerve is a very important anatomic element in the posterior region which must be considered in the most surgical procedures. Implant surgery and nerve repair after pathologic surgeries affect the inferior alveolar canal. Asymmetry in the inferior border of the mandible usually needs shaving. Sometimes the inferior alveolar nerve is attached to the inferior border or the lateral cortex of the mandible due to hemi mandible hyperplasia. In the shaving procedure, the nerve must be protected to prevent sever damage to the neurovascular bundles.

With the existing methods, in which the most common application is the high speed rounding burs, the main risk of inferior alveolar nerve (IAN) transposition is the possible prolonged neurosensory dysfunction due to direct trauma of rotating instruments, traction or pressure on the neurovascular bundles. Moreover, preservation of nerve bundle during surgery may achieve at the expense of copious bone removal. Moreover, preservation of nerve bundle during surgery may achieve at the expense of copious bone removal. Despite the introduction of new techniques and instruments for the purpose of bone removal through nerve lateralization such as piezousurgery, the application of burs remains as the most accepted approach. Although the advantages of piezousurgery have been described through literature, development of micro-cracks in enamel and dentin of teeth in vicinity yet remains and also the vibration of the instrument may cause micro injuries to the nerve. However, nerve bundle preservation is commonly achieved at the expense of copious bone removal.

The conventional methods of the inferior alveolar nerve transposition technique, when used in the severely atrophied posterior mandibles, allows placement of implants with adequate length and good initial stabilization. Moreover, nerve lateralization is not always a choice and in some cases it is the only way for mouth rehabilitation. However, findings show that lateral nerve transposition, resulting in a high percentage of minor inferior alveolar nerve injuries, through primary surgical trauma or secondary complications such as edema or hematoma. In spite of possible surgical reconstruction of nerves, efforts have been made to minimize these disadvantages.

When a pathologic lesion affect the inferior alveolar canal of the mandible, in some cases the resection of the lesion and a part of mandible in the affected side is mandatory. In most of these cases there is no way out but the inferior alveolar nerve cut. For repairing the nerve, the remained part of the nerve in the medial part of the mandible must be removed from the bony chamber and sutured to the distal part of the nerve. Therefore, the buccal wall of the mandibular canal must be removed. As described for the nerve transposition the risk of nerve damage yet remains.

The abovementioned shortcomings, disadvantages and problems are addressed herein and which will be understood by reading and studying the following specification.

### OBJECTS OF THE EMBODIMENTS

The primary object of the embodiments herein is to provide an inferior alveolar nerve (IAN) protector instrument for proper protection of neurovascular bundle and to prevent the traumatic injuries during bone removal.

Another object of the embodiments herein is to provide an inferior alveolar nerve protector instrument for surgeons to perform easier inferior alveolar nerve lateralization, which protects the nerve and preserves the bone for further implant placement.

Yet another object of the embodiments herein is to provide an inferior alveolar nerve protector instrument for safer inferior mandibular shaving.

Yet another object of the embodiments herein is to provide an inferior alveolar nerve protector instrument for more precise repairing of the corrupted nerve due to pathological resections.

These and other objects and advantages of the embodiments herein will become readily apparent from the following detailed description taken in conjunction with the accompanying drawings.

### SUMMARY

The various embodiments herein provide an inferior alveolar nerve (IAN) protector instrument for proper protection of neurovascular bundle and to prevent the traumatic injuries during oral and maxillofacial surgeries. According to one embodiment herein, an inferior alveolar nerve protector instrument is made of stainless steel and comprises a shank, a blade and a handle. The blade is curved with a radius of curvature equal to ⅙-⅛ of a complete circle. The blade has a plurality of orientations. The dissecting edge and the plurality of lateral line angles in the blade are round in shape to avoid untoward cutting. The orientation of blade to be used in a left side of a mouth is different from the orientation of the blade to be used in a right side of a mouth. The shank is an elongated member and the shank is formed to serve as a soft tissue flap retractor (to retract the flap and the tongue simultaneously during the surgery) while supporting the blade. The shank is bent twice with an angle of 120 degrees. The handle is formed in a pear shape for a palm grasp and the handle is provided with a finger rest at a front edge for more control.

According to one embodiment herein, the inferior alveolar nerve protector instrument is applied in the implant surgery. In most cases, a crestal incision is performed with a releasing incision provided at the mesial of canine to uncover and access the mental foramen. The flap is extended distally 2 cm posterior to the last implant insertion place. Once the mucoperiosteal flap is elevated, the mental nerve is exposed. The blade of the instrument is inserted into the mental foramen which protects the mental nerve at the mental foramen. The distal wall of the mental foramen is removed using a small surgical round bur. As the distal wall is removed the blade will be inserted into the inferior alveolar canal smoothly without any additional pressure. The maximum insertion of the blade into the canal estimated and without any obstacle the corticocancellous bone over the nerve removed.

After the initial bone removal, the instrument inserted further into the canal and the procedure repeated till the insertion position of posterior implant achieved. After the complete bone removal, the inferior alveolar nerve is completely released from canal and retracted using a sterile cotton tape. The implant drilling is done and the implants are inserted. The nerve is smoothly repositioned into the canal over the grafted site and the wound is sutured. Post operation radiography is ordered to evaluate the position and condition of both implants and inferior alveolar nerve canal.

During the mandibular inferior border shaving surgeries, in which the inferior alveolar nerve canal is attached or close to the inferior border, after the intra oral incision from the anterior of the ramus in the affected side to the midline, the mucoperiosteal flap is elevated. In severe cases, which the nerve is attached to the inferior border, the inferior alveolar nerve is displaced from its canal in the same manner that is explained earlier in the implant surgery technique with application of the inferior alveolar nerve protector instrument. The border is shaved after the nerve displacement. Finally the nerve is replaced to its normal position and the flap is sutured.

In moderate cases which the inferior alveolar nerve canal is not attached to the inferior border, but still near the border; after the incision, the inferior alveolar nerve protector instrument is inserted into the canal from the mental foramen, after the removal of the distal wall of the foramen as it is described. The concave side of the blade will face the neurovascular bundle while the convex side is toward the inferior border. The border is shaved while the inferior alveolar nerve protector instrument is inside the canal. This may protect the nerve during the application of the high speed hand piece. After the bone removal the flap is repositioned and sutured.

In the pathologically affected mandibles, after the resection of the lesion and cutting of the nerve, to prevent prolonged neurosensory dysfunction, the remained neurovascular bundle in the distal and medial part can be sutured to each other if the length of the lesion is less in the mesio-distal dimension. In other cases, with long space between the medial and distal part, a nerve graft with a microsurgery technique is needed. In these cases part of a peripheral nerve is grafted to the remained nerve. In both situations, the remained bundle in the canal must release to provide a proper part for suturing. In most cases in each side, 1-2 cm of the buccal wall of the inferior alveolar nerve canal is removed with a high speed bur after the insertion of the inferior alveolar nerve protector instrument from the surgical side of the canal. After the suturing and/or grafting, the surgical flap is replaced and sutured.

For the benign lesions, the nerve can be prevented from trauma and cutting by application of the inferior alveolar nerve protector instrument in the canal during the excision and curettage. In these cases, following the removal of the canal wall in the tumor site near the inferior alveolar nerve canal, the inferior alveolar nerve protector instrument is inserted into the canal meticulously and the affected bone surrounding the nerve could be removed without fear of causing trauma to the nerve.

### BRIEF DESCRIPTION OF THE DRAWINGS

The other objects, features and advantages will occur to those skilled in the art from the following description of the preferred embodiment and the accompanying drawings in which:

FIG. 1 illustrates a top perspective view of the inferior alveolar nerve protector instrument according to one embodiment herein.

FIG. 2 illustrates an anterior lateral view of the inferior alveolar nerve protector instrument showing the curve and the convex surface of the blade, according to one embodiment herein.

FIG. 3 illustrates a posterior lateral view of the inferior alveolar nerve protector instrument showing the horizontal and ascending part of the shank, according to one embodiment herein.

FIG. 4 illustrates a top view of the mandibular canal with the right mental foramen exposed and the right inferior alveolar nerve protector instrument tip placed over the mental nerve, according to one embodiment herein.

FIG. 5 illustrates a top view of the mandibular canal with the high speed cutting instrument (surgical bur) removing the lateral (buccal) wall of the mandibular canal and the blade of the inferior alveolar nerve protector instrument protecting the nerve during the osstectomy.

FIG. 6 illustrates a top view of the mandibular canal showing the osstectomy site. The inferior alveolar nerve protector instrument is intact in the canal and the lateral wall is removed without injury to neurovascular bundle.

FIG. 7 illustrates a top view of the mandibular canal showing the neurovascular bundle displaced form the canal with a nerve hook.

FIG. 8 illustrates a preparation of the implant hole and insertion of the implant to the mandibular canal.

FIG. 9 illustrates a post-operation panoramic radiograph showing the implants placed in the inferior alveolar nerve canal without any injury to the nerve.

FIG. 10 illustrates a final panoramic radiography with restorations after implant placement.

Although the specific features of the embodiments herein are shown in some drawings and not in others. This is done for convenience only as each feature may be combined with any or all of the other features in accordance with the present invention.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide an inferior alveolar nerve (IAN) protector instrument for proper protection of neurovascular bundle and to prevent the traumatic injuries during oral and maxillofacial surgeries. According to one embodiment herein, an inferior alveolar nerve protector instrument is made of stainless steel and comprises a shank, a blade and a handle. The blade is curved with a radius of curvature equal to ⅙-⅛ of a complete circle. The blade has a plurality of orientations. The dissecting edge and the plurality of lateral line angles in the blade are round in shape to avoid untoward cutting. The orientation of blade to be used in a left side of a mouth is different from the orientation of the blade to be used in a right side of a mouth. The shank is an elongated member and the shank is formed to serve as a soft tissue flap retractor (to retract the flap and the tongue simultaneously during the surgery) while supporting the blade. The shank is bent twice with 120 degree angle. The handle is formed in a pear shape for a palm grasp and the handle is provided with a finger rest at a front edge for more control.

According to one embodiment herein, the inferior alveolar nerve protector instrument is applied in the implant surgery. The method for implanting the inserts comprises the inferior alveolar nerve protector instrument, a drill for implant drilling and an implant threads. The inferior alveolar nerve protector instrument protects the inferior alveolar nerve, when the implant drilling is done while implanting the implant threads. In most cases, a crestal incision is performed with a releasing incision provided at the mesial of canine to uncover and access the mental foramen. The flap is extended distally 2 cm posterior to the last implant insertion place. Once the mucoperiosteal flap is elevated, the mental nerve is exposed. The blade of the instrument is inserted into the mental foramen which protects the mental nerve at the mental foramen. The distal wall of the mental foramen is removed using a small surgical round bur. As the distal wall is removed the blade will be inserted into the inferior alveolar canal smoothly without any additional pressure. The maximum insertion of the blade into the canal estimated and without any obstacle the corticocancellous bone over the nerve removed.

After the initial bone removal, the instrument inserted further into the canal and the procedure repeated till the insertion position of posterior implant achieved. After the complete bone removal, the inferior alveolar nerve is completely released from canal and retracted using a sterile cotton tape. The implant drilling is done and the implants are inserted. The nerve is smoothly repositioned into the canal over the grafted site and the wound is sutured. Post operation radiography is ordered to evaluate the position and condition of both implants and inferior alveolar nerve canal.

During the mandibular inferior border shaving surgeries, in which the inferior alveolar nerve canal is attached or close to the inferior border, after the intra oral incision from the anterior of the ramus in the affected side to the midline, the mucoperiosteal flap is elevated. In severe cases, which the nerve is attached to the inferior border, the inferior alveolar nerve is displaced from its canal in the same manner that is explained earlier in the implant surgery technique with application of the inferior alveolar nerve protector instrument. The border is shaved after the nerve displacement. Finally the nerve is replaced to its normal position and the flap is sutured.

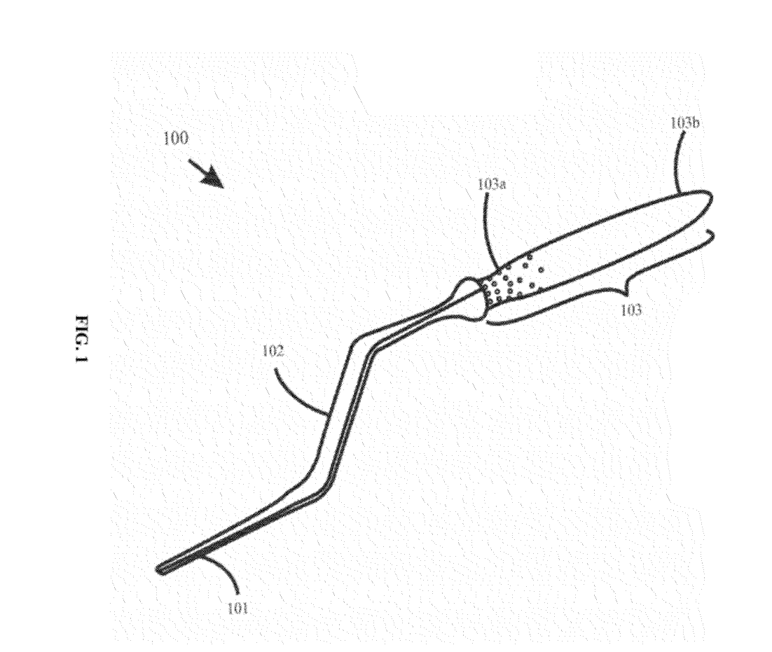

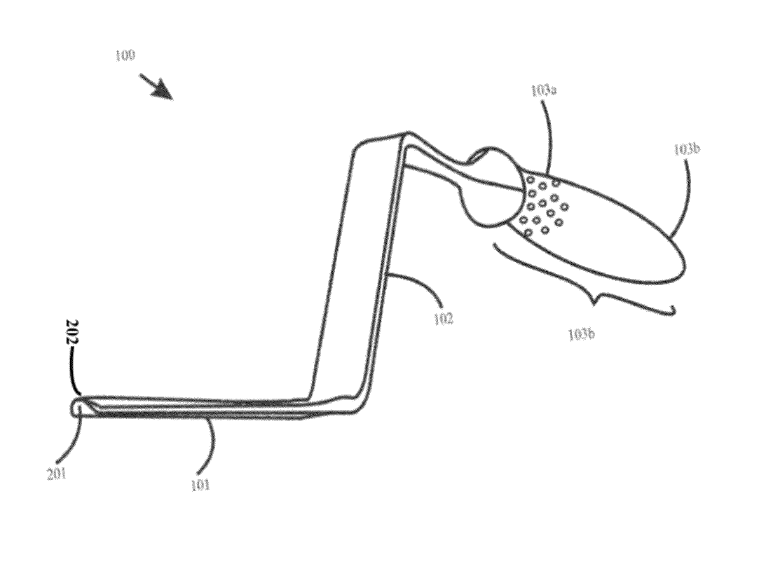

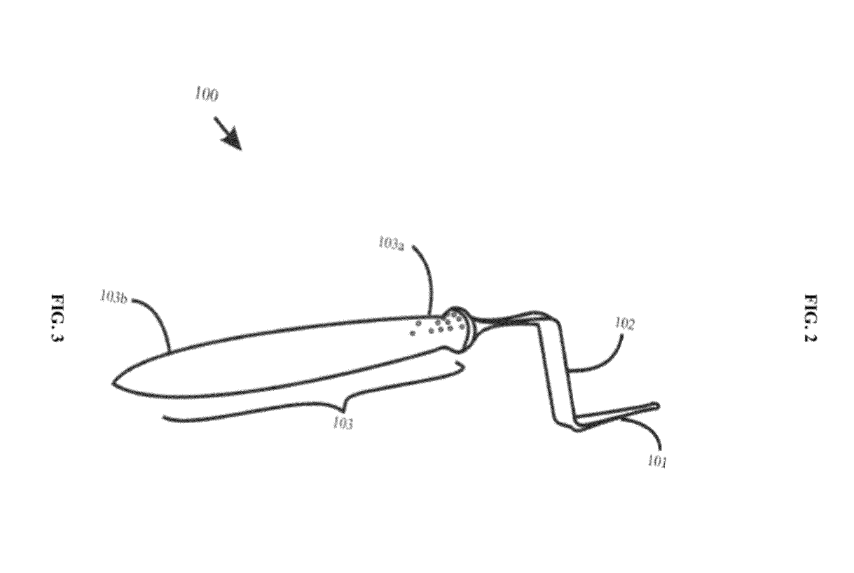

FIG. 1 illustrates a top perspective view of the inferior alveolar nerve protector instrument according to one embodiment herein, while FIG. 2 illustrates an anterior lateral view of the inferior alveolar nerve protector instrument showing the curve and the convex surface of the blade, according to one embodiment herein. FIG. 3 illustrates a posterior lateral view of the inferior alveolar nerve protector instrument showing the horizontal and ascending part of the shank, according to one embodiment herein. With respect to FIG. 1, FIG. 2 and FIG. 3, The inferior alveolar nerve protector instrument 100 has a blade with a curved and the convex shaped surface 201. The inferior alveolar nerve protector instrument 100 as shown in FIG. 1, FIG. 2 and FIG. 3 is made of stainless steel which includes the blade 101, the shank 102 and the handle 103. The shank 102 is formed to serve as a soft tissue flap retractor (to retract the flap and the tongue simultaneously during the surgery) while supporting the blade 101. The handle 103 is designed with a finger rest 103a in the front for more control and the pear shape 103b of the handle 103 is the most comfortable design for palm grasp. The shank 102 is bended twice with 120 degree angle. The blade 101 of the inferior alveolar nerve protector instrument 100 is made in a curve shape 201 which is almost ⅙-⅛ of a complete circle as shown FIG. 2. The dissecting edge and both lateral line angles are rounded to avoid untoward cutting. The inferior alveolar nerve protector instrument 100 is designed separately for right and left sides of the mouth.

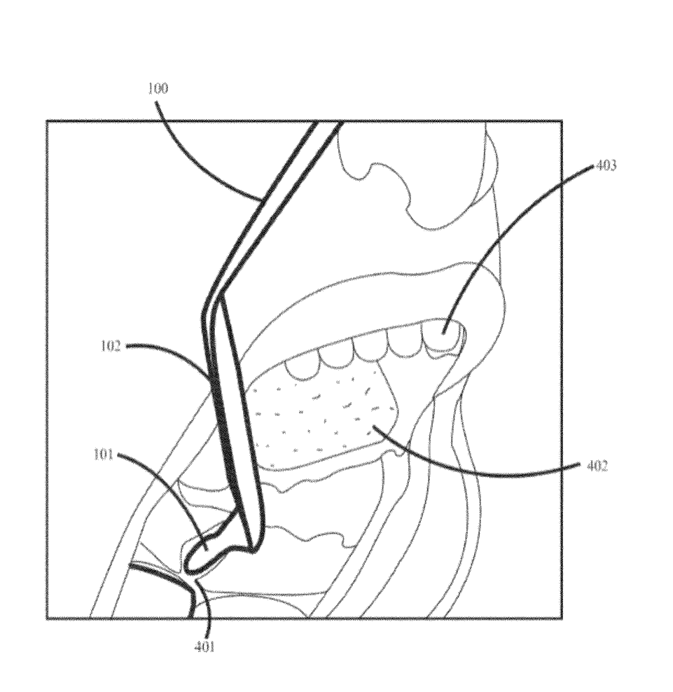

FIG. 4 illustrates a top perspective view of the mandibular canal with a tongue 402, a teeth 403, the right mental foramen 401 exposed and the right inferior alveolar nerve protector instrument 100 tip placed over the mental nerve. In most cases, a crestal incision is performed with a releasing incision provided at the mesial of canine to uncover and access the mental foramen 401. The flap is extended distally 2 cm posterior to the last implant insertion place. Once the mucoperiosteal flap is elevated, the mental nerve is exposed as shown in FIG. 4. The blade 101 of the inferior alveolar nerve protector instrument 100 is inserted into mental foramen 401 in a way that it's concave surface 201 facing the mental nerve, which protect the mental nerve at the mental foramen 401.

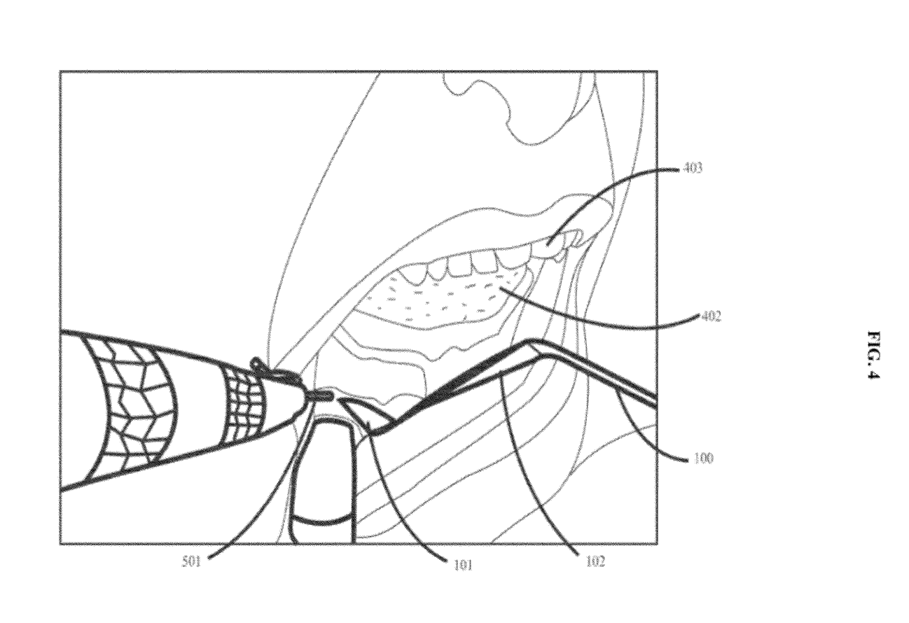

FIG. 5 illustrates a top perspective view of the mandibular canal with the tongue 402, the teeth 403, the high speed cutting instrument (surgical bur) 501 and the blade 101 of the inferior alveolar nerve protector instrument 100. While the high speed cutting instrument (surgical bur) 501 removes the lateral (buccal) wall of the mandibular canal and the blade 101 of the inferior alveolar nerve protector instrument 100 protects the nerve during the osstectomy. The distal wall of the mental foramen 401 is removed using a small surgical round bur 501 with an engine driven hand piece as shown in FIG. 5. Once the distal wall is removed the blade 101 is inserted into the inferior alveolar canal smoothly without any additional pressure. The maximum insertion of the blade 101 into the canal estimated and without any obstacle the corticocancellous bone over the nerve removed. Meanwhile the ascending part of shank 102 serves as a flap and lip retractor. The 120 degree angle between the horizontal and ascending part of the shank 102 as shown in FIG. 1, FIG. 2 and FIG. 3 provides a better retraction during the procedure.

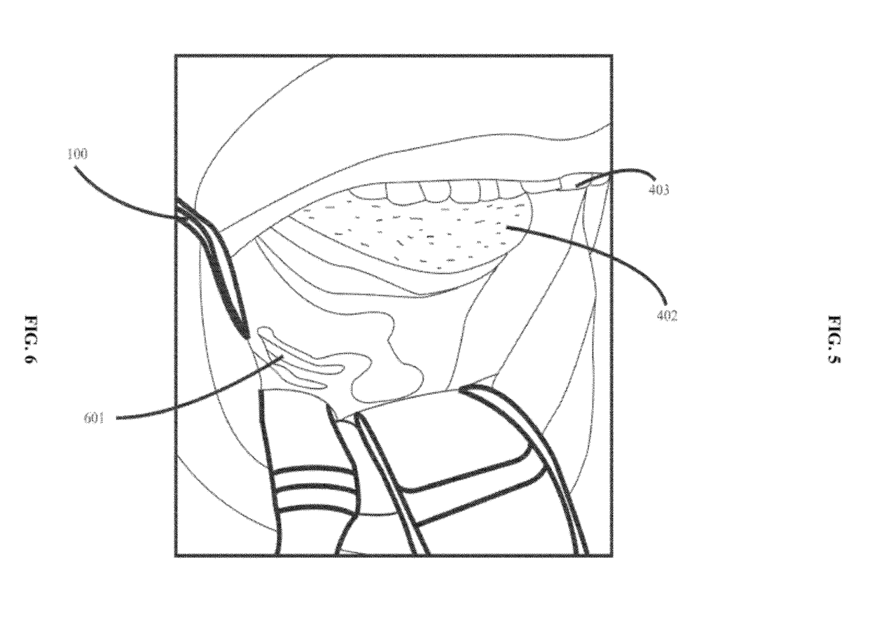

FIG. 6 illustrates a top perspective view of the mandibular canal showing the tongue 402, the teeth 403 and the final view of the osstectomy site. The inferior alveolar nerve protector instrument 100 is intact in the canal and the lateral wall is removed without injury to neurovascular bundle or inferior alveolar nerve 601. The osstectomy is further extended to distal wall, to provide proper site for the implant insertion. Once the osstectomy site is reached the optimum position, the inferior alveolar nerve protector instrument 100 is removed from the canal.

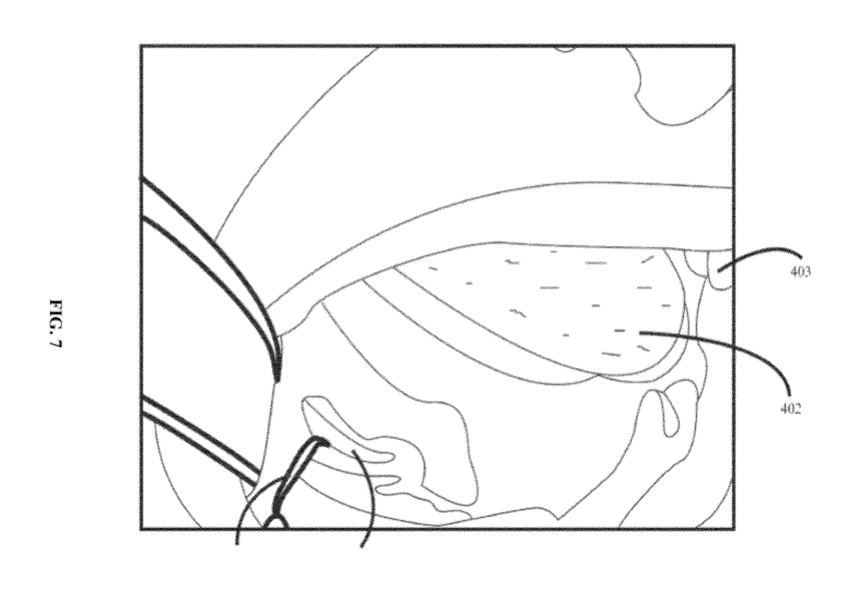

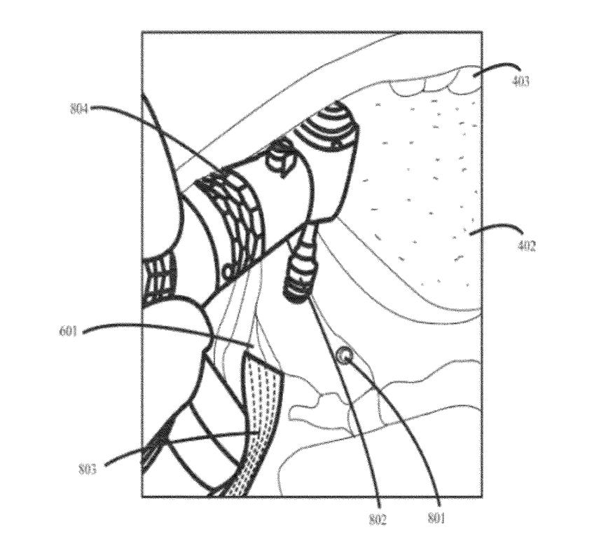

FIG. 7 illustrates a top perspective view of the mandibular canal showing the tongue 402, the teeth 403 and the neurovascular bundle or inferior alveolar nerve 601 displaced form the canal with a nerve hook 701. After the bone removal the inferior alveolar nerve 601 is completely released from the canal and retracted using a sterile cotton or nylon tape 803 as shown in FIG. 8.

FIG. 8 illustrates a top perspective view of the mandibular canal showing the tongue 402, the teeth 403 and the preparation of the implant hole 801 and inserting the implants 802. Before inserting the implants 802, the inferior alveolar nerve 601 is completely released from the canal and retracted using a nylon tape 803. Then the implant drilling is done with a small surgical round bur 804 with an engine driven hand piece to provide an implant hole 801 for implants 802 insertion as shown in FIG. 8. Following implants 802 insertion the bone dust is mixed with an allograft material and packed into the canal over the nude implant threads. The inferior alveolar nerve 601 is smoothly repositioned into the canal over the grafted site and the wound is sutured.

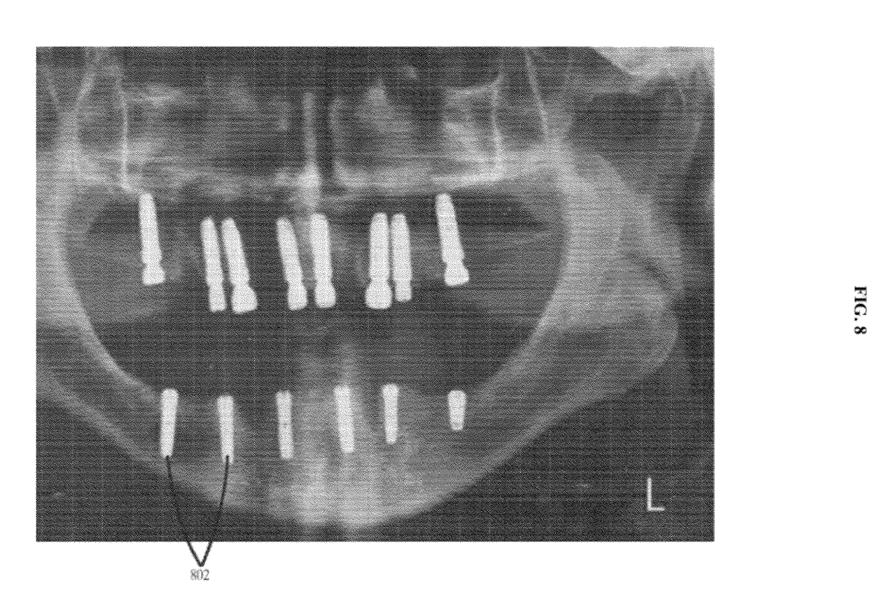

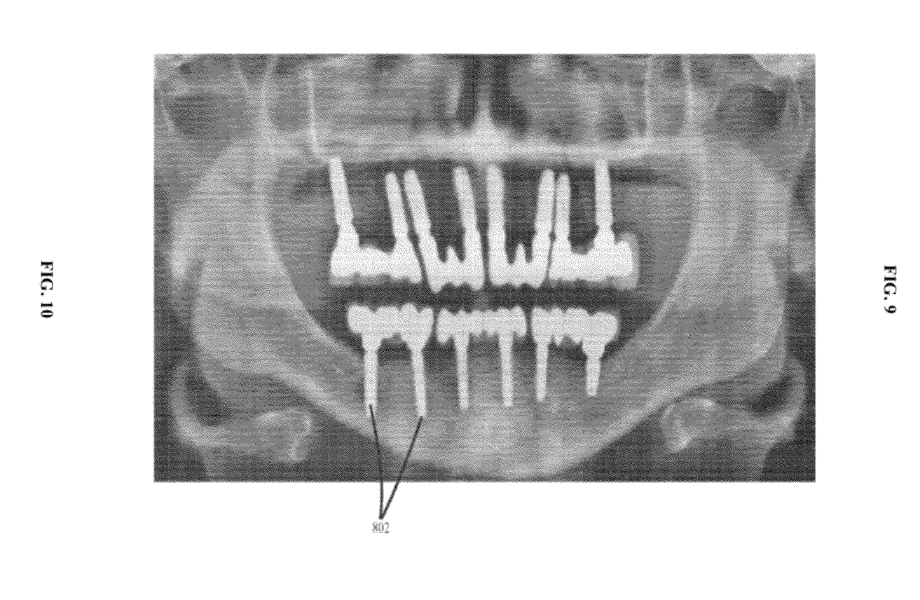

FIG. 9 illustrates a post-operation panoramic radiograph showing the implants placed 802 in the inferior alveolar nerve canal without any injury to the inferior alveolar nerve 601 and FIG. 10 illustrates the final panoramic radiography with restorations after implant 802 placements. Post operation radiography is ordered to evaluate the position and condition of both implants 802 and inferior alveolar nerve canal.

During the mandibular inferior border shaving surgeries, in which the inferior alveolar nerve canal is attached or close to the inferior border, after the intra oral incision from the anterior of the ramus in the affected side to the midline, the mucoperiosteal flap is elevated. In severe cases, in which the nerve is attached to the inferior border, the inferior alveolar nerve is displaced from its canal in the same manner that is explained earlier in the implant surgery technique with application of the inferior alveolar nerve protector instrument of the present invention. The border is shaved after the nerve displacement. Finally the nerve is replaced to its normal position and the flap is sutured.

In moderate cases, in which the inferior alveolar nerve canal is not attached to the inferior border, but still near the border; after the incision, the inferior alveolar nerve protector instrument is inserted into the canal from the mental foramen, after the removal of the distal wall of the foramen as it is described. The concave side of the blade will face the neurovascular bundle while the convex side is toward the inferior border. The border is shaved while the inferior alveolar nerve protector instrument is inside the canal. This may protect the nerve during the application of the high speed hand piece. After the bone removal the flap is repositioned and sutured.

In the pathologically affected mandibles, as it is described, after the resection of the lesion and cutting of the nerve, to prevent prolonged neurosensory dysfunction, the remained neurovascular bundle in the distal and medial part can be sutured to each other if the length of the lesion is less in the mesio-distal dimension. In other cases, with long space between the medial and distal part, a nerve graft with a microsurgery technique is needed. In these cases part of a peripheral nerve is grafted to the remained nerve. In both situations, the remained bundle in the canal must release to provide a proper part for suturing. In most cases in each side, 1-2 cm of the buccal wall of the inferior alveolar nerve canal is removed with a high speed bur after the insertion of the inferior alveolar nerve protector instrument from the surgical side of the canal. After the suturing and/or grafting, the surgical flap is replaced and sutured.

As it was described for the benign lesions, the nerve can be prevented from trauma and cutting by application of the inferior alveolar nerve protector instrument of the present invention in the canal during the excision and curettage. In these cases, following the removal of the canal wall in the tumor site near the inferior alveolar nerve canal, the inferior alveolar nerve protector instrument is inserted into the canal meticulously and the affected bone surrounding the nerve could be removed without fear of causing trauma to the nerve.

The inferior alveolar nerve transposition technique of the embodiments herein when used in the severely atrophied posterior mandibles, allows placement of implants with adequate length and good initial stabilization. Moreover, nerve lateralization is not always a choice and in some cases it is the only way for mouth rehabilitation. The inferior alveolar nerve protector instrument of the embodiments herein provides a proper protection for neurovascular bundle and prevents the traumatic injuries during bone removal. Moreover, as the neurovascular bundle is protected, there is no need to sacrifice essential bone for primary stability of the implant. This results in better primary stability and omit the additional bone grafting and consequently, shorter healing and osseointegration process.

Asymmetry in the inferior border of the mandible usually needs shaving. Sometimes the inferior alveolar nerve is attached to the inferior border or the lateral cortex of the mandible due to hemi mandible hyperplasia. In the shaving procedure, the nerve must be protected to prevent sever damage to the neurovascular bundles. The inferior alveolar nerve protector instrument of the present invention protects the bundle during the shaving procedure.

When a pathologic lesion affects the inferior alveolar canal of the mandible, in some cases the resection of the lesion and a part of mandible in the affected side is mandatory. For repairing the nerve, the remained part of the nerve in the medial part of the mandible must be removed from the bony chamber and sutured to the distal part of the nerve. Therefore, the buccal wall of the mandibular canal must be removed. As described for the nerve transposition the risk of nerve damage yet remains. Thus, application of the inferior alveolar nerve protector instrument of the present invention helps to have less damage with a safer and quicker nerve repair. In addition, in the benign lesion sometimes excision and curettage of the tumor is possible with the preservation of the nerve with the application of the inferior alveolar nerve protector instrument.

The foregoing description of the specific embodiments herein will so fully reveal the general nature of the embodiments herein that others can, by applying current knowledge, readily modify and/or adapt for various applications such specific embodiments herein without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the embodiments with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. An inferior alveolar nerve protector instrument comprising;
a shank;
a blade; and
a handle
wherein the shank is adapted to serve as a soft tissue flap retractor while supporting the blade.

2. The instrument according to claim 1, wherein the blade is curved.

3. The instrument according to claim 1, wherein the blade is curved in a convex shape.

4. The instrument according to claim 1, wherein the blade is curved with a radius of curvature equal to ⅙-⅛ of a perimeter of a complete circle.

5. The instrument according to claim 1, wherein the blade has a dissecting edge and a plurality of lateral lines.

6. The instrument according to claim 1, wherein the dissecting edge and the plurality of lateral lines in the blade are round in shape.

7. The instrument according to claim 1, wherein the shank is an elongate member.

8. The instrument according to claim 1, wherein the shank is made up of a stainless steel material.

9. The instrument according to claim 1, wherein the shank is bent twice with an angle of 120 degrees.

10. The instrument according to claim 1, wherein the handle is formed in a pear shape for palm grasping.

11. The instrument according to claim 1, wherein the handle is provided with a finger rest at a front edge for more control.

12. The instrument according to claim 1, wherein the blade has a plurality of orientations.

13. The instrument according to claim 1, wherein an orientation of a blade to be used in a left side of a mouth is different from an orientation of a blade to be used in a right side of a mouth.
